(19) United States
(12) Patent Application Publication
(10) Pub. No.: US 2012/0090943 A1
(43) Pub. Date: Apr. 19, 2012

(54) CLUTCH PLATE SEPARATION

(76) Inventors: Andrew D. Copeland, Greenwood, IN (US); Alan B. Cookerly, Brownsburg, IN (US); David R. Price, Brownsburg, IN (US)

(21) Appl. No.: 13/237,540

(22) Filed: Sep. 20, 2011

Related U.S. Application Data
(60) Provisional application No. 61/384,590, filed on Sep. 20, 2010.

(51) Int. Cl. F16D 13/58

(52) U.S. Cl. 192/70.11

(57) ABSTRACT

One embodiment of the present invention is a unique clutch system. Another embodiment is a unique clutch system. Another embodiment is a unique method. Other embodiments include apparatuses, systems, devices, hardware, methods, and combinations for clutch systems. Further embodiments, forms, features, aspects, benefits, and advantages of the present application will become apparent from the description and figures provided herewith.

### CROSS REFERENCE TO RELATED APPLICATIONS

The present application claims benefit of U.S. Provisional Patent Application No. 61/384,590 filed Sep. 20, 2010, entitled CLUTCH PLATE SEPARATION, which is incorporated herein by reference.

### FIELD OF THE INVENTION

The present invention relates to clutch systems, and more particularly, to clutch systems configured to separate clutch plates.

### BACKGROUND

Clutch systems that effectively separate clutch plates, e.g., when the clutch system is disengaged, remain an area of interest. Some existing systems have various shortcomings, drawbacks, and disadvantages relative to certain applications. Accordingly, there remains a need for further contributions in this area of technology.

### SUMMARY

One embodiment of the present invention is a unique clutch system. Another embodiment is a unique clutch system. Another embodiment is a unique method. Other embodiments include apparatuses, systems, devices, hardware, methods, and combinations for clutch systems. Further embodiments, forms, features, aspects, benefits, and advantages of the present application will become apparent from the description and figures provided herewith.

### BRIEF DESCRIPTION OF THE DRAWINGS

The description herein makes reference to the accompanying drawings wherein like reference numerals refer to like parts throughout the several views, and wherein:

FIG. 1 schematically illustrates some aspects of a non-limiting example of a clutch system in accordance with an embodiment of the present invention.

FIG. 2 schematically illustrates some aspects of a non-limiting example of a clutch plate assembly in accordance with an embodiment of the present invention.

FIG. 3 schematically illustrates some aspects of a non-limiting example of a clutch plate assembly in accordance with an embodiment of the present invention.

FIG. 4 schematically illustrates some aspects of a non-limiting example of a clutch system in accordance with an embodiment of the present invention.

FIG. 5 schematically illustrates some aspects of a non-limiting example of a clutch plate assembly in accordance with an embodiment of the present invention.

### DETAILED DESCRIPTION

For purposes of promoting an understanding of the principles of the invention, reference will now be made to the embodiments illustrated in the drawings, and specific language will be used to describe the same. It will nonetheless be understood that no limitation of the scope of the invention is intended by the illustration and description of certain embodiments of the invention. In addition, any alterations and/or modifications of the illustrated and/or described embodiment(s) are contemplated as being within the scope of the present invention. Further, any other applications of the principles of the invention, as illustrated and/or described herein, as would normally occur to one skilled in the art to which the invention pertains, are contemplated as being within the scope of the present invention.

In one embodiment, a clutch system includes a clutch having input clutch plates and output clutch plates. Power is transferred through the clutch when the input clutch plates and the output clutch plates are engaged. The clutch system maintains separation between the input clutch plates and output clutch plates when the clutch is disengaged. In one form, magnets are used to separate the input clutch plates and the output clutch plates from each other. In one form, the clutch system includes, in addition to the input clutch plates and the output clutch plates, an input shaft, an output shaft, input drive keys, and output drive keys. In various embodiments, the magnets used to separate the input clutch plates and the output clutch plates may be embedded into any of the components of the system, including the input shaft, the output shaft, input clutch plates, output clutch plates, input drive keys, and/or output drive keys. In one form, the magnets are arranged to repel each other, thereby maintaining separation of the input clutch plates and the output clutch plates

In some embodiments, the input clutch plates and the output clutch plates are separated by air that is circulated between the plates when the clutch is disengaged. In one form, openings, e.g., vent holes, are provided in one or more of the clutch plates and extend through the face of one or more of the plates to allow air to enter the area between adjacent clutch plates. This air creates a buffer to discourage the plates from contacting each other. In some embodiments, a separator may be disposed between discs to act as a pump for drawing air into the disc.

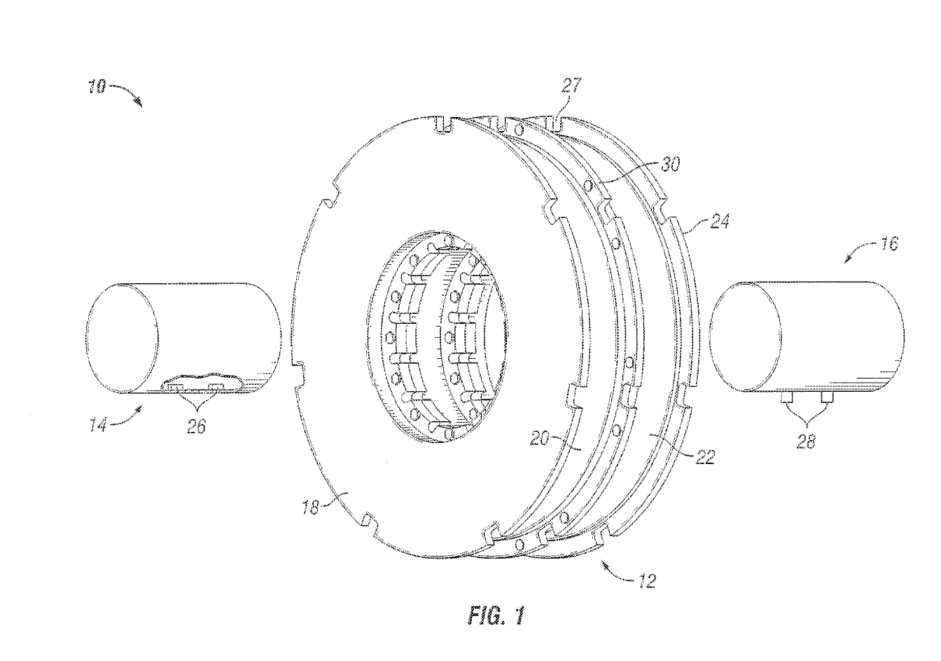

Referring to FIG. 1, some aspects of a non-limiting example of a clutch system 10 in accordance with an embodiment of the present invention are schematically depicted. In one form, clutch system 10 employs magnetic fields and thus magnetic forces to move the clutch plates relative to each other. In a particular form the magnetic fields are configured to separate adjacent clutch plates from contacting each another while the clutch system 10 is disengaged. In a multi-plate clutch system the magnetic fields can be used with a plurality of the plates. In one embodiment the clutch plates are loose fitting, and the magnets are configured to maintain separation of the clutch plates from each other, e.g., to prevent wear and heat generation. In one form, one or more magnets in the form of a magnetic plate disposed between clutch plates is employed.

In one form, clutch system 10 includes one or more magnets 12, an input shaft 14, an output shaft 16, input clutch plates 18, 24, and 30, output clutch plates 20 and 22, input drive keys 26, and output drive keys 28. Input clutch plates are configured to receive input power for transfer to output clutch plates 20 and 22 when clutch system 10 is engaged. Other embodiments can include lesser or greater numbers of input clutch plates and output clutch plates. As used herein, the terms “input” and “output” are used for convenience of description only and are not intended to be limited to embodiments in which the plates are used as only a drive or a driven system. For example, clutch plates 18, 24, and 30 may be used in some applications as input or drive plates, whereas in other applications, clutch plates 18, 24, and 30 may be employed as driven or output plates. Similarly, the output plates 20 and 22 can be used as driven plates in some applications, and as drive plates in others. In still other embodiments, clutch plates 18, 24, and 30, and clutch plates 20 and 22 may alternatingly function as input and output clutch plates.

Magnet(s) 12 are configured to separate clutch plates 18, 24, and 30 from clutch plates 20 and 22 when clutch system 10 is disengaged. In various embodiments, magnets 12 may be embedded into any of the components of clutch system 10. In one form, magnets 12 are installed in more than one component, and are configured to separate clutch plates 18, 24, and 30 from clutch plates 20 and 22 by using magnetic repulsive (repelling) force. In other embodiments, magnets 12 may be configured to separate clutch plates 18, 24, and 30 from clutch plates 20 and 22 using magnetic attractive forces in addition to or in place of magnetic repulsive forces.

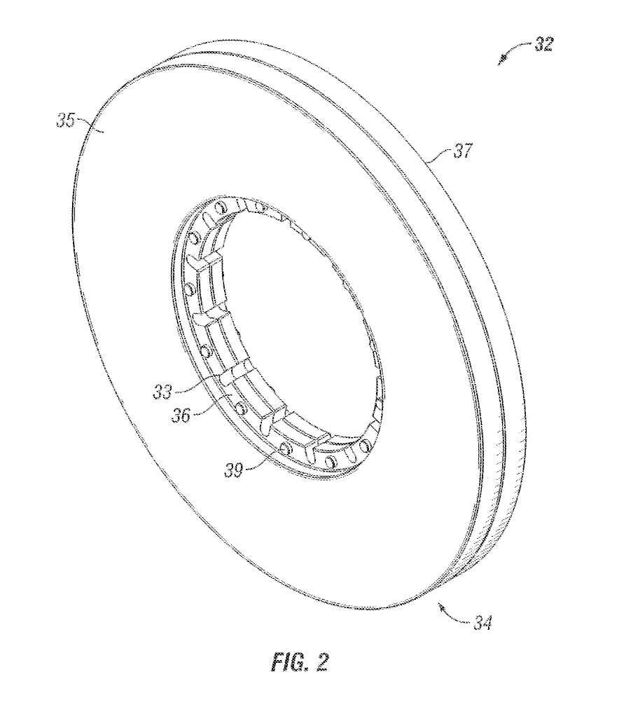

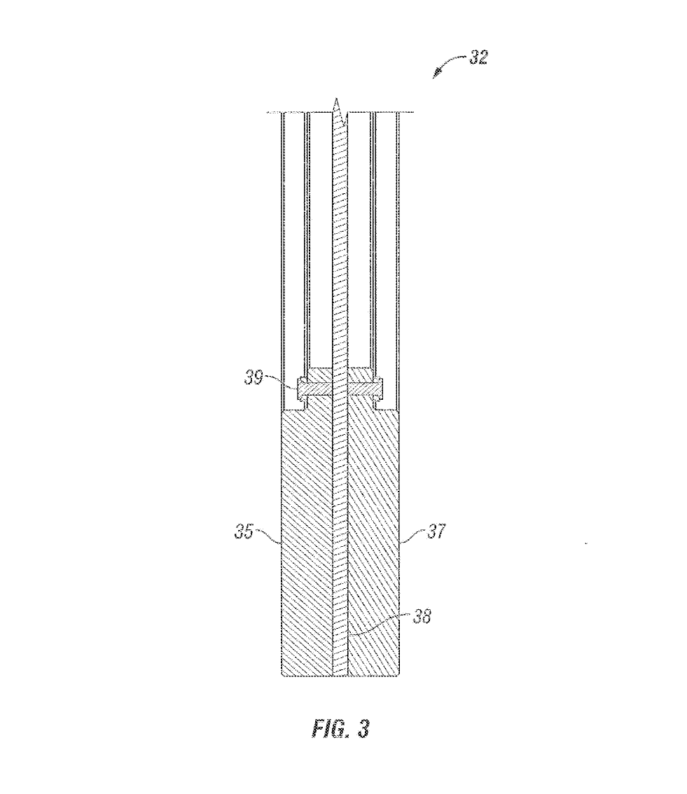

In one form, input drive keys 26 are disposed on an internal portion input shaft 14, and output drive keys 28 are disposed on an external portion of output shaft 16 (note that shafts 14 and 16 are not drawn to the same scale as clutch plates clutch plates 18, 24, and 30 from clutch plates 20 and 22. In other embodiments, one or both of input drive keys 26 and output drive keys 28 may be disposed in other locations. In one non-limiting embodiment, the keys 26 are located on an inner surface of the input shaft 14, which is assembled onto the outer diameter of the input plates 18, 24, and 30, wherein keys 26 engage with slots 27 formed in the input clutch plates 18, 24, and 30. In one non-limiting embodiment, output shaft 16 is assembled into the internal portion of output clutch plates 20 and 22, and keys 28 engage slots the output clutch plates 20 and 22, e.g., in a manner described below in the description of FIGS. 2 and 3. In other embodiments, other arrangements of input shaft 14, output shaft 16, input clutch plates 18, 24, and 30 and output clutch plates 20 and 22 may be employed.

In some embodiments the clutch plates may be an assembly of components. In one non-limiting example, the clutch plates 20, 22, and 30 may be plates having separate parts that are attached together. For example, plates 20, 22, and 30 may be plates having separate halves which, in one form, are mechanically fastened together, such as through the use of rivets, bolts, or screws. An embodiment of a clutch plate having separate parts that are attached together is discussed below.

The present magnetic clutch system may be applied to any variety of clutch systems. Some system include, but are not limited to, automotive transmissions, industrial clutches, axial plate clutches, and high power C/C clutch packs. In one form the clutch system may be used in an aircraft. The aircraft may be powered by a variety of power plants, one of which includes a gas turbine engine. The gas turbine engine can take on a variety of forms such as a turbojet, turbofan, turboshaft, or turboprop. In some forms the gas turbine engine can be an adaptive cycle engine and/or a variable cycle engine.

As used herein, the term “aircraft” includes, but is not limited to, helicopters, airplanes, unmanned space vehicles, fixed wing vehicles, variable wing vehicles, rotary wing vehicles, unmanned combat aerial vehicles, tailless aircraft, hover crafts, and other airborne and/or extraterrestrial (spacecraft) vehicles. Further, the present inventions are contemplated for utilization in other applications that may not be coupled with an aircraft such as, for example, industrial applications, power generation, pumping sets, naval propulsion, weapon systems, security systems, perimeter defense/security systems, and the like known to one of ordinary skill in the art.

In one non-limiting embodiment a vertical/short take off and landing aircraft that uses a lift fan may have a clutch system 10 that engages and disengages the lift fan. For example, clutch system 10 may be engaged to permit generation of lift from the lift fan when desired. In one form the lift fan is driven by a gas turbine engine, and the clutch system 10 is used to engage and disengage the lift fan from a drive shaft coupled to the gas turbine engine.

FIGS. 2 and 3 schematically illustrate some aspects of a non-limiting example of a clutch plate assembly 32 in accordance with an embodiment of the present invention. In one form, clutch plate assembly 32 in the illustrated embodiment can be used as one or both of output clutch plates 20 and/or 22. In other embodiments, clutch plate assembly 32 may be used as one or more of input clutch plates 18, 24, and 30 in addition to or in place of output clutch plates 20 and/or 22. Clutch plate assembly 32 includes a left portion 35 and a right portion 37 that are coupled together using a fastener 39. As used herein, the terms “left” and “right” are used for convenience of description only and are not meant to imply any particular spatial orientation in an assembled clutch plate assembly. The left portion 35 and the right portion 37 can take a variety of forms and shapes, and in one embodiment are mirror images of each other. In one form, fastener 39 is a rivet. In other embodiments, fastener 39 may take one or more other forms, and may be, for example, any useful

device/construction/compound/etc. useful in coupling the left portion 35 and right portion 37 together. To set forth just a few non-limiting examples, the left portion 35 and right portion 37 can be fastened using mechanical devices or chemical adhesives, and furthermore can alternatively and/or additional be fastened using techniques such as welding. Other systems/techniques for fastening the left portion 35 and right portion 37 are also contemplated herein.

The inner diameter of the clutch plate(s) 34 is lugged, having lugs 36 separated by slots 33. Slots 33 are configured to engage drive keys 28 for transferring power between clutch plate 34 and output shaft 16. In other embodiments, other means of engagement may be employed. FIG. 3 depicts a clutch plate assembly 32 with the left portion 35 and the right portion 37 coupled together, which enclose between the two a magnetic plate 38. The magnetic plate can take a variety of forms such as that depicted in FIG. 3. In some embodiments multiple magnetic plates 38 may be used throughout the clutch plate assembly 32 and may, but need not, extend radially through the plate assembly 32. In various embodiments, magnetic plate 38 may be configured to generate a repulsive force in conjunction with magnets 12 mounted in adjacent clutch plates in order to separate the clutch plates when clutch system 10 is disengaged.

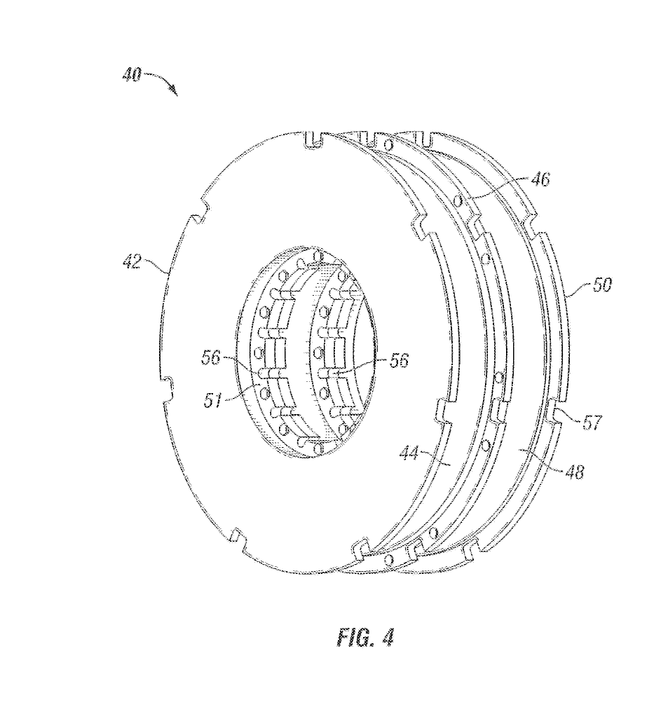

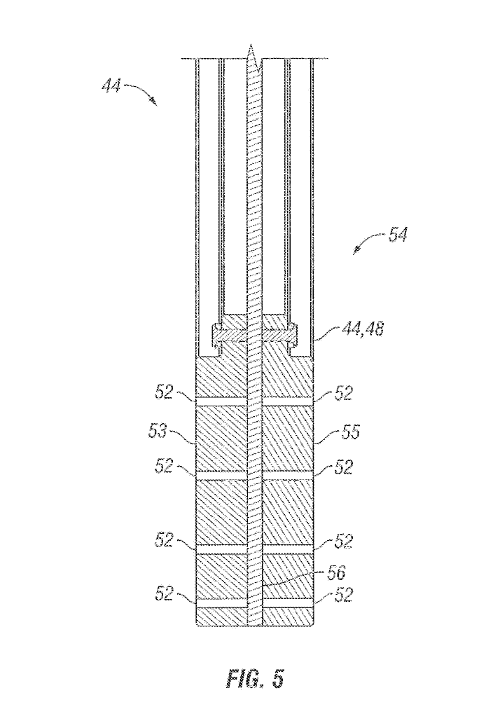

FIGS. 4 and 5 schematically illustrate some aspects of a non-limiting example of a clutch system 40 in accordance with an embodiment of the present invention. Clutch system 40 includes clutch plates 42, 44, 46, 48 and 50. In one form, clutch plates 42, 46 and 48 are input clutch plates, and clutch plates 44 and 48 are output clutch plates. In other embodiments, clutch plates 42, 46 and 50 may be input clutch plates, and clutch plates 44 and 48 may be output clutch plates. In still other embodiments, clutch plates 42, 46 and 50, and clutch plates 44 and 48 may alternatingly function as input and output clutch plates. Although there are five plates depicted in FIG. 5, other embodiments of clutch system 40 may include a lesser or greater number of clutch plates. The embodiment depicted in FIG. 5 illustrates a construction that can be similar for either plates 44 and 48, but it will be understood that the construction or a variation thereof can also be used for any of plates 42, 46, and 50. The plates 42, 44, 46, 48, and 50 can include an array of variations and uses, such as those described above for plates 18, 20, 22, 24, and 30. In one form, the inner diameter of the plates 44 and 48 includes lugs 51 separated by slots 56 for engaging drive keys for an output shaft; and plates 42, 46 and 50 include slots 57.

Clutch system 40 employs air to separate adjacent clutch plates. For example, in one form, air that is in the vicinity of clutch system 40 is redirected to create a buffer zone between any of the plates 42, 44, 46, 48, 50. In other embodiments, air for use in separating the clutch plates may be obtained from other sources, e.g., including compressor bleed air. In one form, air can be routed through an interior of one or more of the plates, in which the plate(s) also include(s) small holes in the face of the plate(s) for the air to exit and create a buffer between the plate(s) and any adjacent plate(s).

As shown in the FIG. 5, air can be received from an area of the plates 44 and 48, such as but not limited to an outer diameter area, and routed through an interior of the plates and eventually through vent holes 52 on the face of plates 44 and 48. The air flowing out of vent holes 52 is used to separate plates 42, 44, 46, 48, and 50, to prevent the plates from contacting each other while the clutch is disengaged. Any number of the plates 42, 44, 46, 48, and 50 can incorporate such air buffer features. Vent holes 52 can be any size/shape/contour/etc and there can be any number of vent holes 52 distributed radially and circumferentially around the plate, to set forth just a few variations. Some forms of the plates may include vent holes 52 on only one side of the plate. Not all vent holes 52 need be the same size/shape/etc. In one embodiment, a clutch plate can be modified to incorporate small holes in the plate along with a separator between discs that acts as a pump to draw air into the disc. In other embodiments, other means may be employed to supply air for separating clutch plates while clutch system 40 is disengaged.

FIG. 5 shows a clutch plate assembly 54 with an example of plate 44 having an air scoop arrangement 56 configured to either receive air or draw air in, and also having vent holes 52 to flow air out. The air scoop arrangement 56 can be any arrangement in which air can be drawn, and directed into an interior of the plates and delivered through the vent holes 52. In one non-limiting form the air scoop 56 is a passage internal to the plates in which an air is provided from an external source, such as through a compressor bleed air. Such an external air can be provided via an air passage formed in one of the input shaft 14 and/or output shaft 16 and delivered to the air scoop 56. In another non-limiting form the air scoop 56 includes members disposed internal to the space between the left portion 53 and right portion 55. The members can be used in some embodiments to entrain and pressurize the air to a level sufficient to carry the air through vent holes 52 and achieve a level of separation between plates.

Embodiments of the present invention include a clutch system, comprising: a plurality of clutch plates; and a plurality of magnets configured to maintain separation between the clutch plates when the clutch system is disengaged.

In a refinement, the clutch plates include at least one input clutch plate and at least one output clutch plate, wherein the plurality of magnets is configured to maintain separation between the at least one input clutch plate and the at least one output clutch plate.

In another refinement, the clutch system further comprises: an input shaft coupled to the at least one input clutch plate; and an output shaft coupled to the at least one output clutch plate.

In yet another refinement, the clutch system further comprises: an input drive key coupled to the input shaft; and an output drive key coupled to the output shaft.

In still another refinement, the magnets are coupled to at least one of the input shaft, the output shaft, the input clutch plate, the output clutch plate, the input drive key, and/or the output drive key.

In yet still another refinement, at least one clutch plate includes lugs.

In a further refinement, the lugs are located on an inner diameter of the at least one clutch plate.

In a yet further refinement, the lugs are located on an outer diameter of the at least one clutch plate.

In a still further refinement, the lugs are located on the inner or outer diameter of the at least one clutch plate.

Embodiments of the present invention include a clutch system, comprising: a first clutch plate; a second clutch plate disposed adjacent to the first clutch plate; and openings in at least one of the first clutch plate and the second clutch plate, wherein the openings are configured to receive air, wherein the clutch system is configured to separate the first clutch plate from the second clutch plate when the clutch system is disengaged using the air.

In a refinement, the at least one of the first clutch plate and the second clutch plate includes an air scoop arrangement configured to draw in the air.

In another refinement, the second clutch plate includes a wear face; and wherein the wear face includes a plurality of vent holes in fluid communication with the air scoop arrangement and operative to expel the air between the first and the second clutch plates to separate the first and the second clutch plates when the clutch system is disengaged.

In yet another refinement, the clutch system further comprises a passage inside the at least one of the first clutch plate and the second clutch plate configured to deliver air from the air scoop arrangement to the vent holes.

In still another refinement, the clutch system further comprises a plurality of lugs on an inner diameter of the clutch system.

Embodiments of the present invention include a method, comprising: disengaging a clutch system, the clutch system including a plurality of clutch plates; and separating the clutch plates using separation means.

In a refinement, the separation means includes an air scoop arrangement to draw in air on an inner clutch plate.

In another refinement, the separation means further includes a plurality of vent holes in one of the clutch plates to expel the air.

In yet another refinement, the separation means further includes a plurality of passages extending between the air scoop arrangement and the vent holes

In still another refinement, the separation means includes a plurality of magnets.

In yet still another refinement, the magnets may be coupled to an input shaft, an output shaft, an input clutch plate, an output clutch plate, an input drive key, and/or an output drive key.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A clutch system, comprising:
a plurality of clutch plates; and
a plurality of magnets configured to maintain separation between the clutch plates when the clutch system is disengaged.

2. The clutch system of claim 1, wherein the clutch plates include at least one input clutch plate and at least one output clutch plate, wherein the plurality of magnets is configured to maintain separation between the at least one input clutch plate and the at least one output clutch plate.

3. The clutch system of claim 2, further comprising:
an input shaft coupled to the at least one input clutch plate; and
an output shaft coupled to the at least one output clutch plate.

4. The clutch system of claim 3, further comprising:
an input drive key coupled to the input shaft; and
an output drive key coupled to the output shaft.

5. The clutch system of claim 4, wherein the magnets are coupled to at least one of the input shaft, the output shaft, the input clutch plate, the output clutch plate, the input drive key, and/or the output drive key.

6. The clutch system of claim 1, wherein at least one clutch plate includes lugs.

7. The clutch system of claim 6, wherein the lugs are located on an inner diameter of the at least one clutch plate.

8. The clutch system of claim 6, wherein the lugs are located on an outer diameter of the at least one clutch plate.

9. The clutch system of claim of 6, wherein the lugs are located on the inner or outer diameter of the at least one clutch plate.

10. A clutch system, comprising:
a first clutch plate;
a second clutch plate disposed adjacent to the first clutch plate; and
openings in at least one of the first clutch plate and the second clutch plate, wherein the openings are configured to receive air,
wherein the clutch system is configured to separate the first clutch plate from the second clutch plate when the clutch system is disengaged using the air.

11. The clutch system of claim 10, wherein the at least one of the first clutch plate and the second clutch plate includes an air scoop arrangement configured to draw in the air.

12. The clutch system of claim 11, wherein the second clutch plate includes a wear face; and wherein the wear face includes a plurality of vent holes in fluid communication with the air scoop arrangement and operative to expel the air between the first and the second clutch plates to separate the first and the second clutch plates when the clutch system is disengaged.

13. The clutch system of claim 12, further comprising a passage inside the at least one of the first clutch plate and the second clutch plate configured to deliver air from the air scoop arrangement to the vent holes.

14. The clutch system of claim 10, further comprising:
a plurality of lugs on an inner diameter of the clutch system.

15. A method, comprising:
disengaging a clutch system, the clutch system including a plurality of clutch plates; and
separating the clutch plates using separation means.

16. The method of claim 15, wherein the separation means includes an air scoop arrangement to draw in air on an inner clutch plate.

17. The method of claim 16, wherein the separation means further includes a plurality of vent holes in one of the clutch plates to expel the air.

18. The method of claim 17, wherein the separation means further includes a plurality of passages extending between the air scoop arrangement and the vent holes

19. The method of claim 15, wherein the separation means includes a plurality of magnets.

20. The method of claim 19, wherein the magnets may be coupled to an input shaft, an output shaft, an input clutch plate, an output clutch plate, an input drive key, and/or an output drive key.
